(19) United States
(12) Patent Application Publication
(10) Pub. No.: US 2011/0299811 A1
(43) Pub. Date: Dec. 8, 2011

(54) LOW-LOSS COLLIMATORS FOR USE IN FIBER OPTIC ROTARY JOINTS

(75) Inventors: Michael O'Brien, Upper Tantallon (CA); James Snow, Bedford (CA)

(73) Assignee: FOCAL TECHNOLOGIES CORPORATION, Dartmouth, NS (CA)

(21) Appl. No.: 13/202,243

(22) PCT Filed: Feb. 25, 2009
(86) PCT No.: PCT/IB09/00347

§ 371 Date: Aug. 18, 2011

(51) Int. Cl. G02B 6/40

(52) U.S. Cl. 385/26

(57) ABSTRACT

Fiber optic collimators are disclosed for use in fiber optic rotary joints (20) providing for improvement in insertion loss performance. One embodiment of the fiber optic collimator has a gradient-index rod lens (61) possessing a pitch of less than one-quarter. Improvement in insertion loss arises due to the increase in the effective focal length of the lens as the pitch is reduced, allowing the collimator to achieve a longer working distance. The increase in the effective focal length is accompanied by an increase in the back focal length of the lens, compared to the zero back focal length of the more typical quarter-pitch gradient-index rod lens. The increased back focal length can be filled by a cylindrical glass spacer (64), to which an optical fiber (68) is attached, resulting in a collimator with very similar form factor to the usual quarter-pitch gradient-index rod lens collimator. The increased back focal length can also be filled by a form of right-angle prism (71), to which an optical fiber is attached such that the fiber is oriented at 90 degrees to the optical axis of the lens useful for applications of pancake-style hybrid slip rings wherein the desired direction of fiber ingress to the rotary joint is perpendicular to the rotation axis of the rotary joint.

### BACKGROUND ART

A fiber optic rotary joint (“FORJ”) typically has a rotor mounted for rotational movement about an axis relative to a stator. Optical fibers communicate with the rotor and stator, respectively. An optical signal is adapted to be transmitted across the interface between the rotor and stator in either direction; that is, from the rotor to the stator, or vice versa.

There are a number of applications in which a data stream carried in one optical fiber on the transmitting side of the rotary interface is to be transmitted through a collimating lens across that interface, with high signal strength and minimal variation in that signal strength at all relative angular positions between the rotor and stator. Such transmitted data stream may be directed by another collimating lens into another optical fiber on the receiving side of the interface. In some applications, the optical fiber on the transmitting side of the interface is permanently mapped to a particular optical fiber on the receiving side.

The transmitting and receiving fibers may be either multimode or singlemode. If there are multiple channels, there may be combinations of data streams carried on multimode fiber pairs and/or singlemode fiber pairs. In some cases, large amounts of data may be transmitted over the FORJ by suitable techniques, such as wavelength division multiplexing (“WDM”).

As shown in FIG. 5 of U.S. Pat. No. 4,725,116, which issued to Nova Scotia Research Foundation Corp., the rotor of a multichannel FORJ may carry an off-axis rotating first channel collimator (i.e., a graded-index rod lens), and a number of additional off-axis rotating channel collimators at various locations spaced successively axially farther away from the first channel collimator and the stator. These various collimators are all spaced radially from the rotational axis of the FORJ. All collimators are arranged so that the axes of the expanding beams emanating therefrom are, during portions of their optical paths, caused to be parallel to the rotation axis of the FORJ. The aggregate disclosure of U.S. Pat. No. 4,725,116 is hereby incorporated by reference.

The first channel expanding beam is transmitted radially into a first housing, where it is reflected by a mirror to an axial direction, and is subsequently focused by another collimator (i.e., another graded-index rod lens) into a stationary fiber mounted on the stator. This completes the first channel, and permits the transmission of high- and consistent-strength signals between the transmitting and receiving fibers. This distance over which the beam must remaining collimated is hereafter referred to as the “working distance”.

An off-axis second channel expanding beam is transmitted radially into a second channel housing located axially farther away from the stator than the first channel housing. In the second channel housing, the second channel expanded beam is reflected by a mirror to an axial direction, and is then further reflected by two additional mirrors to an eccentric location at which the beam is parallel to the rotational axis. The beam is then focused by another collimating lens into a stationary fiber mounted on the stator. This completes the second channel, and permits the transmission of high- and consistent-strength signals between the two fibers. Since it is spaced farther from the stator, the second channel beam must remain collimated over a longer distance than for the first channel beam.

A third channel expanding beam is directed radially into a third housing that is located still farther away from the stator than the first and second housings. The expanded third beam is reflected to an on-axis direction, and is then further reflected by two mirrors to another eccentric location (i.e., not coincident with that of the second channel) at which the beam is parallel to the rotational axis. The third beam is permitted to pass through openings in the first and second housings, and is then focused by another collimating lens into another stationary fiber mounted on the stator. Since it is spaced even farther from the stator, the third channel beam must remain collimated over an even longer distance than for the second channel beam.

The fourth and fifth channels follow similar arrangements. More particularly, the working distance of the expanding beam of the fifth channel is greater than that of the fourth; the working distance of the fourth is greater than that of the third; the working distance of the third is greater than that of the second; and the working distance of the second is greater than that of the first.

The second, third, and higher channel housings are mechanically similar. In this respect, the radial dimension of an n-channel embodiment of this FORJ is identical to that of any other m-channel FORJ, but the axial length of the n-channel FORJ is directly proportional to the number of channels in the FORJ.

A multichannel FORJ may also be used to achieve a multi-channel singlemode FORJ with the use of singlemode fiber collimators. A singlemode fiber only supports transmission of the fundamental fiber mode, which has an intensity distribution in the plane perpendicular to the optical axis of the fiber that is described mathematically by Bessel functions. However, as is commonly known, this can be approximated by a zero-order Hermite-Gaussian beam intensity distribution, and is hereafter referred to as a “Gaussian beam”. The singlemode fiber is cleaved and polished. The wavefront of the light at the end of the fiber is identical to a Gaussian beam waist with infinite radius of curvature, and propagates away from the fiber end as a diverging Gaussian beam. If the fiber end is in close proximity to the focal plane of a lens, then the lens will transform the diverging Gaussian beam into a collimated Gaussian beam. This will achieve true collimation at a collimated beam waist with infinite radius of curvature at a distance from the other focal plane of the lens which can be determined from paraxial Gaussian beam propagation calculations

If an identical second collimator is placed such that the location of its collimated beam waist is coincident with the location of the collimated beam waist of the first collimator, but with the orientation of the collimator reversed by 180 degrees, then the second lens will transform the collimated Gaussian beam into a converging Gaussian beam which will have a beam waist located at the second fiber end that optimizes the coupling of light into the second fiber. Ideally, the optimal coupling efficiency is unity; that is, the insertion loss is zero. However, in the presence of misalignments (e.g., axial errors in the location of the collimated beam waists), a coupling calculation may be used to determine the insertion loss of the optical system. A zero insertion loss can only be achieved through the use of perfect thin lenses, and that the use of real lenses (i.e., those possessing various aberrations and index mismatches) will increase the minimum achievable insertion losses to various extents.

The results of these calculations are displayed in FIG. 1A, which is a plot of fiber-to-lens focal plane distance, normalized to maximum zero-loss value, πω₀²/λ (ordinate) vs. lens focal plane-to-lens focal plane distance (working distance), normalized to maximum zero-loss value, λf²/πω₀² (abscissa). FIG. 1A assumes that two identical singlemode collimators are used. For a given light of wavelength λ, fiber mode field radius ω₀, and lens effective focal length f, there is a maximum working distance, or separation between the two collimators, at which zero insertion loss, equal to λf²/πω₀², can be achieved, when measured between the two focal planes of the collimating lenses closer to where the beam is collimated. At this maximum zero-loss working distance, the fiber distances are each equal to the Rayleigh length of the Gaussian beam, πω₀²/λ, when the fiber distances are measured with respect to the focal plane of the collimating lens that is closer to the fiber. At a working distance of zero, when measured from the collimating lens focal planes that are closer to the collimated beam, the fiber distances are each zero when measured from the collimating lens focal plane that is closer to the fiber.

For working distances less than the maximum zero-loss working distance, there are two optimal fiber distances at which zero insertion loss is calculated. One is less than the Rayleigh length, and the other is greater than the Rayleigh length. It is generally preferable to select the smaller of the two optimal fiber distances because the collimator pair may be used for a wider range of working distances with smaller insertion losses. For working distances greater than this maximum value, an optimum insertion can be achieved with a fiber distance that is less than the Rayleigh length, but the value of the optimum insertion loss rises rapidly with working distance.

### DISCLOSURE OF THE INVENTION

With parenthetical reference to the corresponding parts, portions or surfaces of the disclosed embodiment, merely for purposes of illustration and not by way of limitation, the present invention provides a multi-channel fiber optic rotary joint (20) having one member (e.g., a rotor) (49) mounted for rotation relative to another member (e.g., a stator) (21) about an axis of rotation (x-x). The improved joint broadly comprises: a first fiber optic collimator (61) mounted on one of the members; a second fiber optic collimator (61) mounted on the other of the members; and intervening optical elements (46, 44) defining an optical path between the collimators that permits the transmission of optical signals between the first and second collimators with minimal variation in the strength of the transmitted signals over all permissible relative angular positions between the members, the optically-connected collimators providing one channel for data transmission across the rotary joint.

The improved joint may further include: a plurality of the first fiber optic collimators (61); a plurality of the second fiber optic collimators (61); and a plurality of intervening optical elements (46, 44) between respective ones of the first fiber optic collimators and respective ones of the second fiber optic collimators to define a plurality of data transmission channels; and wherein the fiber optic collimators include either identical multimode optical fibers or identical singlemode optical fibers, located in proximity to the focal plane of their associated collimating lenses,

The fiber optic collimators (61) may include identical gradient-index rod lenses (62),

The collimators of the data transmission channels may have varying working distances.

A first number of the data transmission channels may include fiber optic collimators (61) may have working distances that may be achieved with ideally zero insertion losses by means of quarter-pitch gradient-index rod lenses (62) affixed to the fibers (68) by means of optically-transparent epoxy (65), defining a desired axial form factor,

A second number of the data transmission channels include fiber optic collimators (61) that have working distances that may not be achieved with ideally zero insertion losses by means of quarter-pitch gradient-index lenses, but that may be achieved by means of shorter-than-quarter-pitch gradient-index rod lenses (62).

A third number of the data transmission channels include fiber optic collimators (61) that may have working distances that may not be achieved with ideally zero insertion loss either by means of quarter-pitch gradient-index rod lenses or shorter-than-quarter-pitch gradient-index rod lenses (62), but that may be achieved with acceptable non-zero insertion losses by means of shorter-than-quarter-pitch gradient-index rod lenses.

The shorter-than-quarter-pitch gradient-index rod lenses (62) may be affixed to cylindrical glass spacers (64) by means of a suitable optically-transparent epoxy (63), and the axial lengths of the cylindrical glass spacers may be selected to locate the focal planes (62c, 62d) of the shorter-than-gradient-index rod lenses proximal to the cylindrical glass spacers physically outside of the cylindrical glass spacers.

The cylindrical glass spacers (64) may have diameters equal to, or less than, the diameters of the shorter-than-quarter-pitch gradient-index rod lenses.

The shorter-than-quarter-pitch gradient-index rod lenses (61) and the cylindrical glass spacers (64) may have end faces which are polished to orientations which are not perpendicular to the optical axes of the shorter-than-quarter-pitch gradient-index rod lenses, for the purpose of minimizing back reflections.

The optical fibers may be affixed to the cylindrical glass spacers by means of a suitable optically-transparent epoxy (65).

The fiber optic collimators may include shorter-than-quarter-pitch gradient-index rod lenses (62), cylindrical glass spacers (64), and optical fibers (68) that conform to the desired axial form factor.

The shorter-than-quarter-pitch gradient-index rod lenses (70) may be affixed to cube reflector prisms (71) by means of a suitable optically-transparent epoxy (74), with the width of the cube reflector prisms selected to locate the focal planes of the shorter-than-quarter-pitch gradient-index rod lenses physically outside of the cube reflector prisms, and with the optical paths of the shorter-than-quarter-pitch gradient-index rod lenses thereby bent by 90 degrees,

The cube reflector prisms may include a highly-reflective metallic coating (79) applied to a prepared glass substrate, and a second glass substrate affixed to the highly-reflective metallic coating by means of a suitable optically-transparent epoxy.

The optical fibers may be affixed to the cube reflector prisms, by means of a suitable optically-transparent epoxy such that the optical fiber axes are oriented at 90 degrees to the optical axes of the shorter-than-quarter-pitch gradient-index rod lenses,

One of the cube reflector prisms may be replaced by a cylindrical glass spacer of equal optical path length, wherein the optical fiber is oriented parallel to the optical axis of the shorter-than-quarter-pitch gradient-index rod lens.

The shorter-than-quarter-pitch gradient-index rod lenses (78) may be affixed to right-angle prisms (79) by means of a suitable optically-transparent epoxy (82), with the width of the right-angle prisms selected to locate the focal planes of the shorter-than-quarter-pitch gradient-index rod lenses physically outside of the right-angle prisms, with the optical path of the shorter-than-quarter-pitch gradient-index rod lenses thereby bent by 90 degrees.

The right-angle prisms may have a highly-reflective multi-layer dielectric coating (79a) applied to the hypotenuse.

The optical fibers may be affixed to the right angle prisms by means of an optically-transparent epoxy such that the optical fiber axes are oriented at 90 degrees to the optical axes of the shorter-than-quarter-pitch gradient-index rod lenses,

One of the right-angle prisms may be replaced by a cylindrical glass spacer of equal optical path length, wherein the optical fiber is oriented parallel to the optical axis of the shorter-than-quarter-pitch gradient-index rod lens.

It will be appreciated that a desired embodiment of a multichannel FORJ may require channels 1, . . . , A, A+1, B, B+1, C, C+1, D with D>C>B>A>1 that fall into one of the following three categories:

1. Channels 1 through, to and including A that require collimator working distances that are less than the working distances achievable by quarter-pitch gradient-index rod lenses and for which zero insertion loss, as calculated in the Background, may be achieved.
2. Channels A+1 through, to and including C that require collimator working distances that are greater than the maximum working distance that is achievable by quarter-pitch gradient-index rod lenses and for which non-zero insertion loss, as calculated in the Background, may be achieved, but for which the non-zero insertion loss is acceptable given the specifications of the FORJ.
3. Channels C+1 through, to and including D that require collimator working distances that are greater than the maximum working distance that is achievable by quarter-pitch gradient-index rod lenses and for which non-zero insertion loss, as calculated in the Background, may be achieved, but for which the non-zero insertion loss is not acceptable given the specifications of the FORJ.

In U.S. Pat. No. 4,725,116, the collimators are constructed using quarter-pitch gradient-index rod lenses. Such lenses are preferred because the focal planes of these lenses coincide with the physical ends of these lenses. Direct attachment of the fibers to the lenses is easily achieved by means of, for example, a small axial thickness of a suitable UV-cured epoxy. For working distances less than the maximum zero-loss working distance, selecting the smaller of the two optimal fiber distances results in a spacing between the fiber and the lens which is less than the Rayleigh length of the beam. For working distances greater than the maximum zero-loss working distance, the single optimal fiber distance is similarly less than the Rayleigh length of the beam. For a spacing filled with air, the Rayleigh length of the beam expanding from a singlemode fiber end is generally in the tens of microns. Such a small spacing may be advantageously filled with an optically-transparent epoxy, increasing the spacing by a multiplicative factor equal to the index of refraction of the optical transparent epoxy. This yields a one-piece collimator assembly with the fiber end encapsulated in epoxy preventing contamination, and which is radially symmetric about the optical axis of the collimating lens.

Reducing the pitch of a gradient-index rod lens will increase the effective focal length of the lens which will, in turn, increase the maximum zero-loss working distance of the lens as described above. For instance, at quarter-pitch and at 1550 nm, the Selfoc® SLW-1.8 lens (Selfoc® is a registered trademark of Nippon Sheet Glass Co. Ltd., 1-7 Kaigan2-Chome Minato-ku, Tokyo, Japan) has an effective focal length of 1.93 mm, a length of 4.8 mm, and a back focal length of 0 mm. If the use of SMF-28® singlemode optical fiber (SMF-28® is a trademark of Corning Inc., One Riverfront Plaza, Corning, N.Y.) is assumed, with a mode field radius of 5.2 μm at 1550 nm, then the calculations described in the Background indicate a maximum zero-loss working distance of 68.0 mm, with an optimal fiber distance (in air) of 54.8 μm from the other ends of each of the lenses.

A reduction of the pitch of the gradient-index lens to 0.11, for instance, results in an effective focal length of 3.01 mm, a length of 2.11 mm, and a back focal length of 2.32 mm. The calculations above then indicate a maximum zero-loss working distance of 165 mm, with an optimal fiber distance (in air) of 2.37 mm from the other ends of each of the lens. Such a large fiber distance is difficult to fill completely with an optically-transparent epoxy. However, a cylindrical glass spacer of similar diameter as the lens may be attached by means of, for example, a UV-cured epoxy to the shortened lens on the fiber side. The glass spacer possesses an axial length calculated to cause the focal plane of the lens and the end of the spacer to coincide. In this case, the optimal fiber distance (in air) from the spacer is again equal to the Rayleigh length of the beam, and can be advantageously filled with, for instance, a UV-cured epoxy. This provides a collimator assembly that is radially symmetric about the optical axis of the collimating lens, and thus conforms to the same radial form factor as a standard gradient-index rod lens collimator. This is the preferred embodiment of the FORJ in U.S. Pat. No. 4,725,116, but is capable of a longer working distance with lower insertion loss.

The reduction in pitch of the gradient-index lens does cause the axial length of the collimator to change slightly. Using the above example, a 0.11 pitch Selfoc® SLW-1.8 lens has an axial thickness of approximately 2.11 mm, and has a back focal length of 2.32 mm. The use of a glass spacer having a refractive index of 1.5, for example, requires that the spacer have an axial thickness equal to the back focal length of the lens multiplied by the refractive index of the spacer material (in this example equal to 3.48 mm), with the total axial length of the lens-spacer assembly summing to 5.6 mm, as compared to 4.8 mm for the quarter-pitch Selfoc® SLW-1.8 lens on its own. The use of other spacer materials will change the overall axial length of the lens-spacer assembly. However, the range of variation in the length will be small. For instance, using a glass spacer material having a refractive index of 1.4 results in a lens-spacer assembly axial length of approximately 5.4 mm. Using a glass spacer material having a refractive index of 1.6 results in a lens-spacer assembly axial length of approximately 5.8 mm.

There is a lower limit to the pitch of a short-pitch gradient-index lens that can feasibly be used in the above collimator assembly. The first constraint is due to physical limitations on the axial thickness to which a glass cylinder may be polished and/or have an anti-reflection coating applied. The second constraint is due to the change in numerical aperture of the short-pitch gradient-index lens. At a quarter-pitch, the Selfoc® SLW-1.8 lens has a numerical aperture of 0.46, which can be calculated either from the gradient-index terms of the lens itself, or, more simply, by dividing the semi-diameter of the lens by the effective focal length. As the effective focal length of the lens increases, the numerical aperture decreases. At the above example of a 0.11 pitch Selfoc® SLW-1.8 lens, the numerical aperture is 0.30, which is still larger than the 1% intensity numerical aperture of 0.14 for the Corning SMF-28® singlemode fiber.

The insertion loss improvement has been experimentally shown. Two standard quarter-pitch gradient-index rod lenses were used to build a collimator pair with a 150 mm working distance. The desired working distance is approximately 2.2 times the maximum zero-loss working distance of 68 mm, and the insertion loss can then be estimated to be approximately 2.5 dB. Using this collimator pair in a fiber optic rotary joint requiring this working distance results customarily in a measured insertion loss of approximately 6 dB. A second collimator pair was built using 0.11 pitch gradient-index rod lenses, with the same working distance. Again, the theoretically-expected insertion loss may be determined from FIG. 3. The desired working distance is less than the maximum zero-loss working distance of 165 mm, and the insertion loss can then be estimated to be 0 dB. Using this collimator pair in the same fiber optic rotary joint requiring this working distance resulted in a measured insertion loss of approximately 2.5 dB, for an improvement of 3.5 dB. The improvement in insertion loss was greater than expected theoretically, which can be attributed to variations in the actual working distances of the two collimator pairs and the required working distance in the rotary joint.

In reference to the desired embodiment of the multichannel FORJ described above, the incorporation of collimators using short-pitch gradient-index rod lenses results in channels that fall into one of the following four categories:

1. Channels 1 through, to and including, A that require collimator working distances that are less than the working distances achievable by quarter-pitch gradient-index rod lenses, and for which zero insertion loss, as calculated supra, may be achieved; that is, with no improvement in insertion loss after incorporating short-pitch gradient-index rod lenses.
2. Channels A+1 through, to and including B that require collimator working distances that are greater than the working distances achievable by quarter-pitch gradient-index rod lenses, and for which non-zero insertion loss, as calculated supra, may be achieved. The non-zero insertion loss is acceptable, given the specifications of the FORJ, but additionally requires collimator working distances that are less than the working distances achievable by given short-pitch gradient-index rod lenses. The zero insertion loss was calculated supra; that is, with improvement in insertion loss after incorporating short-pitch gradient-index rod lenses.
3. Channels B+1 through, to and including C that require collimator working distances that are greater than the working distances achievable by quarter-pitch gradient-index rod lenses, and for which non-zero insertion loss, as calculated supra, may be achieved, but for which the non-zero insertion loss is acceptable given the specifications of the FORJ, but which additionally require collimator working distances that are to a lesser extent greater than the working distances achievable by given short-pitch gradient-index rod lenses and for which a smaller non-zero insertion loss, as calculated supra, may be achieved; that is, with improvement in insertion loss after incorporating short-pitch gradient-index rod lenses.
4. Channels C+1 through, to and including D that require collimator working distances that are greater than the maximum working distance that is achievable by quarter-pitch gradient-index rod lenses and for which non-zero insertion loss, as calculated supra, may be achieved, but for which the non-zero insertion loss is not acceptable given the specifications of the FORJ, but which additionally require collimator working distances that are to a lesser extent greater than the working distances achievable by given short-pitch gradient-index rod lenses and for which the non-zero insertion loss is acceptable given the specifications of the FORJ; that is, with increase in the number of channels which have acceptable insertion loss after incorporating short-pitch gradient index rod lenses.

It will thus be apparent that Channels 1 through, to and including A are not improved by reducing the pitch of the gradient-index rod lens. It is advantageous to continue to use quarter-pitch gradient-index rod lenses for these channels since the collimators will be simpler to build. It will also be apparent that channels A+1 through, to and including C will be improved by reducing the pitch of the gradient-index rod lens. It will only be advantageous to reduce the pitch of the gradient-index rod lenses used for these channels in the presence of a need to reduce the insertion loss. It will further be apparent that Channels C+1 through, to and including D require the use of short-pitch gradient-index rod lenses in order to be incorporated into the FORJ and meet the required specification on insertion loss.

As is commonly known, other quarter-pitch gradient-index rod lenses exist with longer effective focal lengths than the SLW-1.8 lens referred to above. Examples of such lenses include the Selfoc® SLW-3.0 lens and the Selfoc® SLW-4.0 lens, with effective focal lengths at quarter-pitch at 1550 nm of 3.11 mm and 4.19 mm, respectively. These lenses provide for maximum zero-loss working distances of 176 mm and 320 mm, respectively, which are significantly longer than maximum zero-loss working distance of the 0.11 pitch SLW-1.8 lens calculated above.

However, these alternate lenses have diameters of 3.0 mm and 4.0 mm, respectively. An embodiment disclosed in U.S. Pat. No. 4,725,116 designed with quarter-pitch SLW-1.8 lenses would require no re-design work to incorporate short-pitch SLW-1.8 lenses with spacers in those channels that require the longer working distance; that is, the housings for those channels which do require the use of short-pitch gradient-index rod lenses will continue to be identical the housings for those channels which do not require the use of short-pitch gradient-index rod lenses.

Reducing the pitch of a gradient-index rod lens will increase the back focal length of the lens, which provides a fiber-to-lens spacing large enough to permit the construction of non-axially symmetric collimators. The increased back focal length of the short-pitch gradient-index rod lens is sufficient to allow the insertion of a right-angle prism between the fiber and the lens, and allows the fiber to exit the FORJ at a right angle to the rotation axis of the FORJ without the need to increase the length of the FORJ to permit a low-loss bending radius on the fiber. In such an application, the higher effective focal length of the lens, and the commensurate increase in the working distance of the collimator, is not the primary goal. Such a collimator may be instead be advantageously used to achieve a pancake-style rotary joint wherein one or both of the rotating and stationary fibers enter the FORJ perpendicular to the rotation axis of the rotary joint. This can reduce the axial length of a single channel FORJ, such as disclosed in U.S. Pat. Nos. 4,398,791, 5,039,193 and/or 5,588,077, the aggregate disclosures of which are also incorporated herein by reference.

Accordingly, the general object of the invention is to provide improved low-loss collimators.

Another object is to provide low-loss collimators for use in fiber optic rotary joints.

These and other objects and advantages will become apparent from the foregoing and ongoing written specification, the drawings and the appended claims.

### BRIEF DESCRIPTION OF THE DRAWINGS

FIG. 1A is a plot of fiber-to-lens focal plane distance, normalized to maximum zero-loss value, πω₀²/λ (ordinate) vs. lens focal plane-to-lens focal plane distance (working distance), normalized to maximum zero-loss value, λf²/πω₀² (abscissa).

FIG. 1B is a plot of lens effective focal length (ordinate) vs. pitch (abscissa) for a commercially-available gradient-index rod lens, specifically the SLW-1.80 Selfoc® lens.

FIG. 1C is a plot of lens length (ordinate) vs. pitch (abscissa) for a commercially-available gradient-index rod lens, specifically the SLW-1.80 Selfoc® lens.

FIG. 2 is a longitudinal vertical sectional view of a fiber optic rotary joint, this view being similar to FIG. 5 of U.S. Pat. No. 4,725,116, except as otherwise noted.

FIG. 3A is a schematic view of a first embodiment of the present invention, this embodiment having a leftward fiber/ferrule subassembly attached by means of an optically-transparent epoxy to an intermediate glass spacer, which, in turn, is attached by means of an optically-transparent epoxy to a rightward shorter-than-quarter-pitch gradient-index rod lens.

FIG. 3B is a detail view of the gradient-index rod lens shown in FIG. 3A.

FIG. 3C is a detail view of the glass spacer shown in FIG. 3A.

FIG. 3D is a detail view of the fiber/ferrule subassembly shown in FIG. 3A.

FIG. 4A is a schematic view of a second embodiment of the present invention, this embodiment including a fiber/ferrule subassembly attached by means of optically-transparent epoxy to a cube reflector prism having a highly-reflective metallic coating, which cube is, in turn, attached by means of optically-transparent epoxy to a shorter-than-quarter-pitch gradient-index rod lens.

FIG. 4B is schematic view of the cube reflector prism shown in FIG. 4A.

FIG. 5A is a schematic view of a third embodiment of the present invention, this embodiment including a fiber/ferrule subassembly attached by means of optically-transparent epoxy to a right-angle prism possessing a highly-reflective multi-layer dielectric coating, which prism is, in turn, attached by means of optically-transparent epoxy to a shorter-than-quarter-pitch gradient-index rod lens.

FIG. 5B is a schematic view of the right-angle prism shown in FIG. 5A.

### DESCRIPTION OF THE PREFERRED EMBODIMENTS

At the outset, it should be clearly understood that like reference numerals are intended to identify the same structural elements, portions or surfaces consistently throughout the several drawing figures, as such elements, portions or surfaces may be further described or explained by the entire written specification, of which this detailed description is an integral part. Unless otherwise indicated, the drawings are intended to be read (e.g., cross-hatching, arrangement of parts, proportion, degree, etc.) together with the specification, and are to be considered a portion of the entire written description of this invention. As used in the following description, the terms “horizontal”, “vertical”, “left”, “right”, “up” and “down”, as well as adjectival and adverbial derivatives thereof (e.g., “horizontally”, “rightwardly”, “upwardly”, etc.), simply refer to the orientation of the illustrated structure as the particular drawing figure normally faces the reader. Similarly, the terms “inwardly” and “outwardly” generally refer to the orientation of a surface relative to its axis of elongation, or axis of rotation, as appropriate.

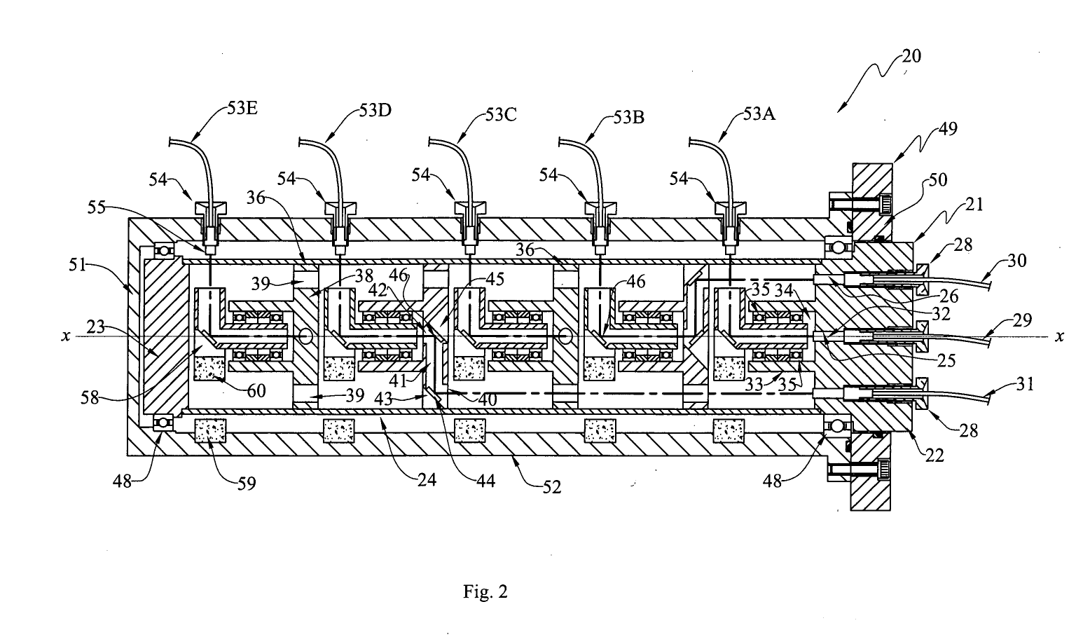

### Fiber Optic Rotary Joint (FIG. 2)

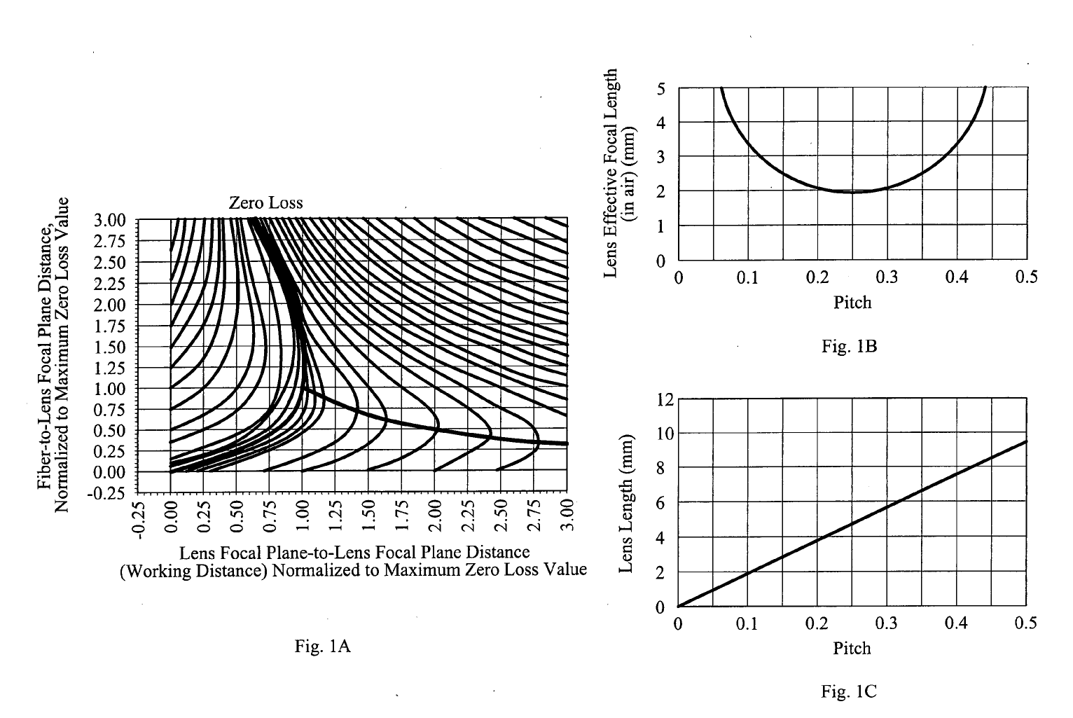

Referring now to FIG. 1, a first embodiment of a fiber optic rotary joint, generally indicated at 20, will be described. FIG. 2 is similar to FIG. 5 of U.S. Pat. No. 4,725,116, except as described herein. Hence, the following description will paraphrase the language used in the specification of the aforesaid patent. This particular embodiment is shown with five optical inputs and outputs, although it should be understood that the structure could be altered to accommodate any number of input and output channels, the only constraint being the degree of transmission loss that can be tolerated.

Joint 20 includes a stator 21 having a rightward head end 22, a leftward tail end 23, and a horizontally-elongated optically-transparent cylindrical tube 24 connecting the head end to the tail end. The head end is cylindrical, and includes a horizontal central through-bore 25 and four circumferentially-spaced horizontal through-bores, severally indicated at 26, encircling central bore 25. Only two of bores 26 may be seen in FIG. 2. Each bore is adapted to receive a means 28 by which an optical signal-carrying fiber is connected to the head end. In the disclosed embodiment, the rotary joint accommodates five such fibers, one for central bore 25 and one for each of surrounding bores 26. The three visible fibers are designated 29, 30 and 31, respectively. Each fiber terminates at a graded-index rod lens 32, such as a Selfoc® lens, which serves to enlarge the diameter of an optical signal leaving the lens or to reduce the diameter of an optical signal entering the lens, depending on the direction of propagation of the optical signal.

On its rear side, the head end 22 defines a supporting means, which includes a leftwardly-extending horizontal cylindrical tubular boss 33 having a large diameter bore 34, which, in turn, communicates with the central bore 25 in the head end. In fact, the lens 32 attached to the central fiber 29 protrudes slightly into the bore 34. A pair of axially-spaced bearing assemblies 35, 35 is secured to boss 33 within bore 34 for a purpose to be described hereinafter.

Spaced along, and non-rotatably secured to, the transparent tube 24 is a plurality (four being shown) of separate supporting means or units, severally indicated at 36. Since they are identical to one another, only one will be specifically described.

Each support unit 36 is cylindrical and includes a large diameter portion 38 provided with three circumferentially-spaced through-bores 39, 39, 39. These bores are aligned with the encircling bores 25, 26 provided through the head end of the stator. Each support unit further includes a fourth eccentrically-positioned axially-oriented through-bore 40 which intersects a radially-extending bore 41, the latter, in turn, intersecting a short axial bore 42 which enters the portion 38 from the rear surface thereof. At the intersection of bores 40 and 41, a seat 43 is machined to receive a reflecting mirror 44 which is positioned at an angle of 45° with respect to an axially-directed optical path and to a radially-directed optical path. At the intersection of the bores 41 and 42, another seat 45 is machined so as to receive a reflecting mirror 46 which is also arranged at an angle of 45° with respect to axial and radial paths. Mirror 46 is arranged to reflect light to mirror 44, and vice versa.

The supporting unit 36 closest to the head end is oriented and secured within the tubular boss 33 so that its bore 34 and mirror 46 are on a line to intercept an optical signal directed from central fiber 29. Since the other three bores 39, 39, 39 passing through unit 36 are unimpeded, optical signals directed to, or from, the other fibers will pass through appropriate ones of these bores. The leftward next-adjacent unit 36 is oriented at an angle of 90° with respect to the just-described rightwardmost unit so that an optical signal directed from its fiber will be intercepted by its mirror 44, the signals from the remaining two fibers continuing through the unimpeded bores. The leftward next-adjacent unit 36 is oriented at an angle of 90° with respect to the previous unit (and at an angle of 180° with respect to the unit closest to the head end) so that an optical signal directed from its fiber, having passed through both preceding support units is intercepted by its mirror 44. The optical signal directed from the remaining fiber will be intercepted by its mirror 44 of the rearmost support unit 36, that unit being oriented at an angle of 90° with respect to the preceding unit.

In each case, the signal from one of the fibers is reflected by one of mirrors 44 in a corresponding support unit from a path which is parallel to the joint axis to a path which is normal or transverse thereto. In each instance, such reflected signal is again reflected through an angle of 90° so as to be on-axis by the mirror in the corresponding support unit.

Each support unit 36 includes a central boss, a central bore therein communicating with the bore, and bearing assemblies secured within the central bore. Each support unit, in turn, carries a reflecting unit which is substantially identical in construction to that previously-described. Thus, each reflecting unit includes a cylindrical section, a section at right angles thereto, radial and axial bores, a reflecting mirror and a permanent magnet. Each reflecting unit is rotatably supported by the bearing assemblies included in the corresponding support unit, there being one reflecting unit for each support unit, including the support unit formed at the back side of the stator head end.

The tail end 23 of the stator is cylindrical in nature and is secured to the left marginal end of transparent tube 24. One bearing assembly 48 is mounted on the stator tail end, and another bearing assembly 48 is mounted on the stator head end 22.

The rotary joint further includes a rotor 49, which has a head end 50, a tail end 51, and a horizontally-elongated tubular body 52 connecting the head end to the tail end. The rotor head end 50 is journalled on the stator head end 22 by the bearing assembly 48, and the rotor tail end 51 is journalled on the stator tail end 23 by the other bearing assembly 48, the rotor tubular body 52 surrounding the stator transparent tube 24. In order to seal the interior of the joint, an O-ring seal is provided in the rotor cap member for sealing engagement with the stator head end. The cap member is connected to the rotor head end by machine screws, and is sealed thereto by conventional O-ring.

The rotor tubular body 52 has a plurality (five in this case) of longitudinally-spaced optical signal-carrying fibers, severally indicated at 53, connected thereto by connecting means 54. From head end-to-tail end, the rotor fibers are individually identified by reference numbers 53A, 53B, 53C, 53D and 53E, respectively. Each rotor fiber terminates in a graded-index rod lens 55 having the same focal length as each stator rod lens 32. Each lens 55 extends through the annular body so as to be positioned closely adjacent the stator transparent tube 24. The optical axis of each rotor fiber and its lens coincides with a transverse plane containing the optical path defined in the bore 56 of a corresponding reflecting unit 58.

Diametrically opposite each fiber and its lens, the rotor annular body 52 carries a permanent magnet 59 of a polarity opposite that of a corresponding magnet 60 carried by reflecting unit 58.

Optical signals entering the stator fibers are transmitted to the rotor fibers via optical paths that include rotatable reflecting members, which members serve to transmit an optical signal from the axis of the joint to the rotating rotor fibers, the reflecting members being driven, and maintained in alignment with the rotor fibers, by the magnetic interaction between the magnet pairs 59, 60.

In describing the structure of the stator 21 it was pointed out that an optical signal emanating from each of the stator fibers 29, 30, 31, etc. will pass into the stator and will include a portion which passes from a corresponding support unit along the axis of the joint. That portion is reflected by the mirror 44 of the reflecting unit rotating in the corresponding support unit and passes through the transparent tube for reception by the graded-index lens 55 of the corresponding rotor fiber, which fiber is maintained in alignment with the optical path exiting the reflecting unit by the previously-described magnetic interaction. In the embodiment shown, the signal from the central stator fiber 29 will be directed to rotor fiber 53A; the signal from stator fiber 30 will be directed to rotor fiber 53B; the signal from stator fiber 31 will be directed to rotor fiber 53C; and the signals from the other stator fibers will be received by rotor fibers 53D and 53E, respectively. Of course, signals could just as easily be transmitted in a reverse direction from the rotor fibers through the reflected paths to the stator fibers. Additionally, a combination of signal directions could be used with, say, signals passing in the rotor-to-stator direction along two paths and signals passing in the stator-to-rotor direction along the other paths. Crossing of the various signal paths during rotation of the rotor does not seriously affect the signals since the duration of such interference is infinitesimal.

While not separately illustrated, it should be understood that alternative magnet configurations could also be used in the multi-channel rotary joint of FIG. 2.

It is a characteristic of Selfoc® lenses, when used as an optical coupling, that transmission losses are proportional to the distance between them. In the embodiment just described, such transmission losses will be at a minimum for the coupling between fibers 29 and 53A, but will be progressively larger for each channel as the separation between lens increases. Therefore, although the number of channels which could be carried by such a rotary joint is virtually unlimited, the maximum number of channels to be carried will be determined by the maximum degree of transmission losses that can be tolerated.

### First Embodiment

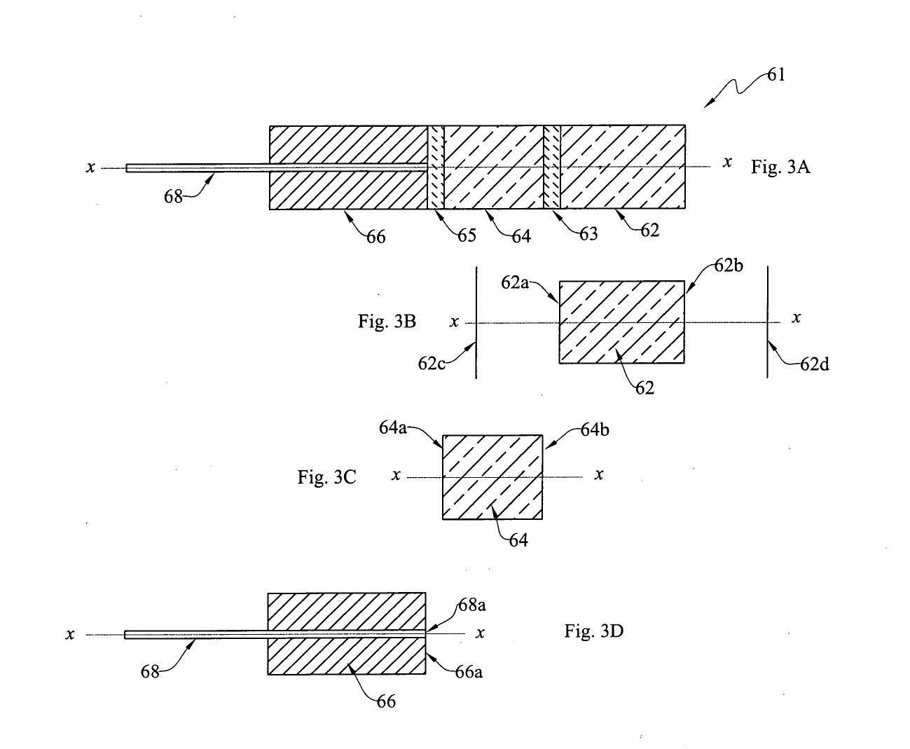

### FIGS. 3A-3D

Referring now to FIG. 3A, a first embodiment of the present invention provides a radially-symmetric short-pitch collimator, generally indicated at 61. This collimator includes a short-pitch gradient-index rod lens 62 secured to one end of a cylindrical glass spacer 64 via an intermediate optically-transparent epoxy 63. The other end of the spacer is secured to a fiber/ferrule subassembly via an intermediate optically-transparent epoxy 65. The fiber/ferrule subassembly is shown as having an annular ferrule 66 surrounding the right marginal end portion of an optical fiber 68. This fiber may be either a multimode or singlemode optical fiber

In FIG. 3B, the short-pitch gradient-index rod lens 62 is shown as being a horizontally-elongated cylindrical rod-like member having a horizontal axis x-x, a spacer-side left end 62a, a right end 62b, a spacer-side focal plane 62c, and a right focal plane 62d. The ends 62a, 62b may be oriented either perpendicularly to the optical axis x-x (as shown), or oriented at small angles to a plane perpendicular to the optical axis for the purpose of reducing back-reflections from the ends. It will be appreciated that the normal vectors to the ends are preferentially coplanar.

In FIG. 3C, the cylindrical glass spacer 64 is also shown as being a horizontally-elongated cylindrical rod-like member having a horizontal axis x-x, a ferrule/fiber-side left end 64a, and a spacer-side right end 64b. The diameter of the glass spacer is preferably equal to, or less than, the diameter of the gradient-index rod lens 62. The spacer has an axial length equal to, or less than, the focal length of the gradient-index rod lens when calculated in the medium of the spacer such that the rod lens spacer-side focal plane 62c is located outside of the spacer. The ends 64a, 64b of the glass spacer may be either perpendicular to the central axis, or oriented at small angles from a plane perpendicular to the central axis for the purpose of reducing back-reflections from the ends. It will be appreciated that the normal vectors to the ends are preferentially coplanar.

Referring again to FIG. 3A, the left end 62a of the gradient-index rod lens may be affixed to the right end 64b of the cylindrical glass spacer by means of a very small thickness 63 of UV-cured epoxy, such that the optical axis x-x of the lens is coincident with the central axis x-x of the spacer, and such that neither the UV-cured epoxy nor the spacer extends radially outwardly beyond radial extent of the lens. In this respect, the use of a spacer with a smaller diameter than that of the lens is desirable. In the arrangement discussed above, in which one or more ends of the components are oriented at small angles from planes perpendicular to their respective axes and in which the angled ends of each component are meant to contact each other across the thin UV-cured epoxy bond, it will be appreciated that to maintain the coincidence of the central and optical axes, the small angles should be equal in magnitude, and the spacer and the lens should be oriented such that the normal vectors to the angled ends are coplanar.

In FIG. 3D, the optical fiber 68 has a central axis x-x, and an optical fiber spacer-side end 68a. The ferrule has a central axis x-x, and a ferrule spacer-side end 66a. The ferrule preferentially possesses a diameter less than the diameter of either the lens or the spacer. The fiber end preferentially coincides with the ferrule end and the fiber central axis is parallel to, and preferably coincident with, the ferrule central axis. The optical fiber spacer-side end is advantageously identically oriented with the ferrule spacer-side end. The optical fiber central axis is advantageously parallel to the ferrule central axis. The ferrule preferentially possesses a diameter equal to less than the diameter of the cylindrical glass spacer. The ferrule ends may be either arranged in planes perpendicular to axis x-x, or oriented in planes arranged at a small angle from a plane perpendicular to the central axes for the purpose of reducing back-reflections from the ends.

Referring once again to FIG. 3A, the right end of the fiber/ferrule subassembly is affixed to the left end of the glass spacer by means of a thickness of UV-cured epoxy 65 such that, preferentially, the central axis of the fiber/ferrule subassembly is oriented coincidentally with the optical axis of the rod lens and the glass spacer, and such that neither the UV-cured epoxy or the fiber/ferrule subassembly extends radially outwardly past the radial extent of the lens. In this respect, the use of a ferrule with a smaller diameter than that of the spacer is desirable. In the arrangement described above wherein one or more ends of the components are oriented at small angles from their respective axis and wherein the angled ends of each component are meant to contact each other across the UV-cured epoxy bond, it will be appreciated that to maintain the coincidence of the central and fiber axes that the small angles should be equal in magnitude and the ferrule and the spacer are oriented such that the normal vectors to the angled ends are coplanar.

By these means, the radial form factor of the collimator assembly is identical to the radial form factor of a similar axially-symmetric collimator assembly manufactured using a standard quarter-pitch lens.

Lens 61 may be substituted for lenses 32 and/or 55 in FIG. 2.

### Second Embodiment

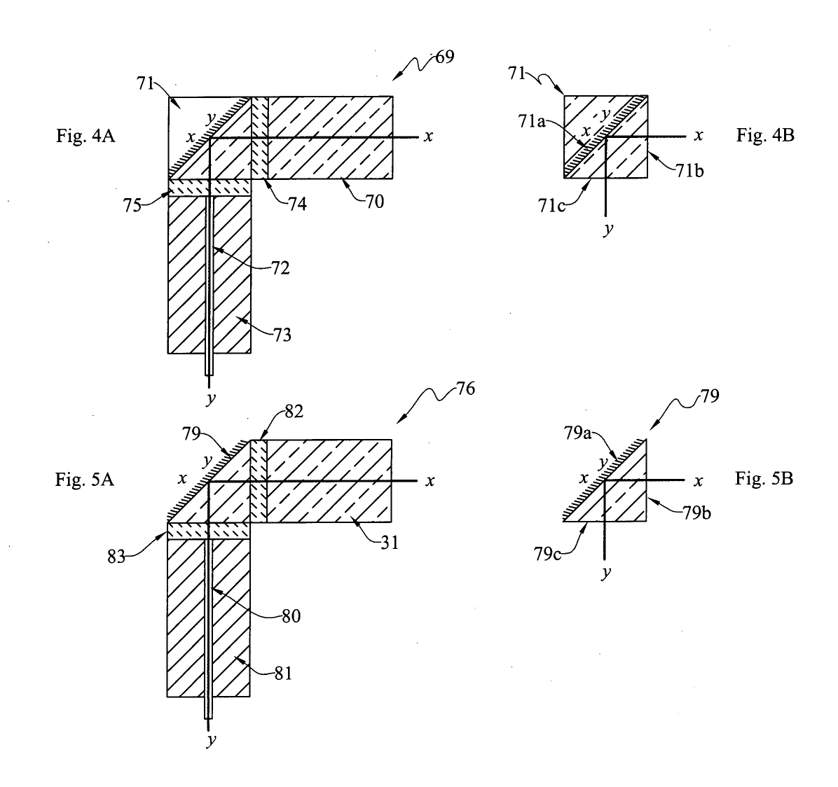

### FIGS. 4A and 4B

Referring now to FIG. 4A, a second embodiment of the present invention, generally indicated at 69, comprises an axially non-symmetric short-pitch collimator suitable for use in a fiber optic rotary joint requiring fiber ingress oriented at right angles to the rotation axis of the rotary joint, or for use in applications where size restrictions prevent the use of an axially-symmetric collimator and bending of the fiber to a right angle ingress. The second embodiment is comprised of similar subcomponents to the first general embodiment described in FIG. 3A. Thus, collimator assembly 20 includes a short-pitch gradient-index rod lens 70, a right-angle cube reflector prism 71 (which replaces the glass spacer of the first embodiment), and the fiber/ferrule subassembly comprised of the optical fiber 72 within a ferrule 73. The left end of lens 70 is secured to the right face of prism 71 by means of an optically-transparent epoxy 74. Similarly, the upper end of the fiber/ferrule subassembly is affixed to the lower face of prism 71 by means of an optically-transparent epoxy 75. These epoxies can be suitable UV-cured epoxies.

Referring to FIG. 4B, the cube reflector prism possesses a cube reflector prism 71 is shown as having an optically-reflective metallic layer 71a extending diagonally through the cube reflector prism. Thus, light enters the prism along a central horizontal axis x-x, intersects its vertical right face 71b, and exits via a central vertical axis y-y intersecting its horizontal lower face 71c, or vice versa. Preferably, the central horizontal axis of the cube reflector prism is coincident with the optical axis of the short-pitch gradient-index rod lens, and the central vertical axis of the cube reflector prism is coincident with the central axis of the fiber/ferrule subassembly. Normals to the cube reflector prism ends are preferably perpendicular to one another. The cube reflector prism possesses a width equal to, or marginally less than, the focal length of the short-pitch gradient-index rod lens when calculated in the medium of the prism such that the short-pitch gradient-index rod lens spacer-side focal plane is located outside of the cube reflector prism. In this embodiment, the spacer-side end of the rod lens is generally perpendicular to the optical axis of the rod lens and the end of the fiber/ferrule subassembly is generally perpendicular to the central axis of the fiber/ferrule subassembly.

The use of the cube reflector prism is advantageous to the use of a standard right-angle prism, either with or without a reflective coating. In the case of a standard right-angle prism without a reflective coating, the desired 90-degree bending of the beam would be achieved by means of total internal reflection at the tilted surface. For the common glass, BK7, for example, the critical angle of incidence where total internal reflection occurs is approximately 41.8 degrees when the transmitted medium is air. In the present embodiment, the angle of incidence of the central ray of the beam exiting the fiber is 45 degrees, which is greater than the critical angle. However, the beam is diverging from the fiber and a significant portion of the beam energy will be transmitted through the tilted surface. Thus a reflective surface is required.

In the case of a standard right-angle prism with a metallic reflective coating, the portion of the beam energy lost at the tilted surface due to absorption is dependent upon the metal chosen. Aluminum, the most common metal chosen for achieving a 90 degree bending of a beam in glass, has a reflectivity of less than 90% at the common fiber optic transmission wavelength of 850 nm, increasing to approximately 95% at the common fiber optic transmission wavelengths of 1310 nm and 1550 nm. This yields insertion loss penalties of greater than 0.46 dB at 850 nm, and 0.22 dB at 1310 nm and 1550 nm. Improvement upon this may be achieved by means of a gold reflective coating, which has a reflectivity of greater than 97.5% at all three transmission wavelengths. This yields insertion loss penalties of less than 0.11 dB. However, it is difficult to deposit gold directly on to glass, thus the cube reflector prism may be built, for example, by depositing gold on the hypotenuse of a standard right-angle prism prepared with an adhesion layer of, for example, chromium, then affixing to this coating the hypotenuse of a second right-angle prism by means of, for example, UV epoxy. With this solution, only one of the constituent right-angle prisms is used for the optical path.

In the case of a standard right-angle prism with a multi-layer dielectric coating, the desired 90 degree bending of the beam may be achieved with high reflectivity at the desired transmission wavelength or wavelengths.

Collimator 69 may be used with fiber optic rotary joint 20.

### Third Embodiment

### FIGS. 5A and 5B

Referring now to FIG. 5A, a third embodiment of the present invention, generally indicated at 76, includes a short-pitch gradient-index rod lens 78, a right-angle triangular reflector prism 79 (which replaces the glass spacer of the first embodiment), and the fiber/ferrule subassembly comprised of the optical fiber 80 within a ferrule 81. The left end of lens 78 is secured to the right face of prism 79 by means of an optically-transparent epoxy 82. Similarly, the upper end of the fiber/ferrule subassembly is affixed to the lower face of prism 79 by means of an optically-transparent epoxy 83. These epoxies can be suitable UV-cured epoxies.

Referring to FIG. 5B, the cube reflector prism 79 is shown as having an optically-reflective metallic layer 79a on its inclined rear face. Thus, light enters the prism along a central horizontal axis x-x by passing through its vertical right face 32c, and exits through its horizontal lower face 32e along a central vertical axis y-y intersecting its, or vice versa. Preferably, the central horizontal axis of the cube reflector prism is coincident with the optical axis of the short-pitch gradient-index rod lens, and the central vertical axis of the triangular reflector prism is coincident with the central axis of the fiber/ferrule subassembly. Normals to the right-angle prism ends are preferentially perpendicular to one another. The right-angle prism possesses a width equal to, or marginally less than, the focal length of the short-pitch gradient-index rod lens when calculated in the medium of the prism such that the short-pitch gradient-index rod lens spacer-side focal plane is located outside of the right-angle prism. In this embodiment, the spacer-side end of the rod lens is generally constrained to be perpendicular to the optical axis of the rod lens, and the end of the fiber/ferrule subassembly is generally constrained to be perpendicular to the central axis of the fiber/ferrule subassembly.

Collimator 76 may be used with fiber optic rotary joint 20.

### Modifications

The present invention contemplates than many changes and modifications may be made. For example, the collimator assembly may have an optical path, either linear or angled. The reflector prism may be a cube with a mirrored diagonal surface, or may be a triangular prism with a mirrored back surface. Other changes may be made as well.

Therefore, while several embodiments of the improved low-loss collimators have been shown and described, and several modifications thereof discussed, persons skilled in this art will readily appreciate that various additional changes and modifications may be made without departing from the spirit of the invention, as defined and differentiated by the following claims.

What is claimed is:

1. A multi-channel fiber optic rotary joint having one member mounted for rotation relative to another member about an axis of rotation, comprising:
a first fiber optic collimator mounted on one of said members;
a second fiber optic collimator mounted on the other of said members; and
intervening optical elements defining an optical path between said collimators that permits the transmission of optical signals between said first and second collimators with minimal variation in the strength of the transmitted signals over all permissible relative angular positions between said members, said optically-connected fiber optic collimators providing one channel for data transmission across said rotary joint,

2. A multi-channel fiber optic rotary joint according to claim 1, comprising:
a plurality of said first fiber optic collimators;
a plurality of said second fiber optic collimators; and
a plurality of intervening optical elements between respective ones of said first fiber optic collimators and respective ones of said second fiber optic collimators to define a plurality of data transmission channels; and
wherein said fiber optic collimators include either identical multimode optical fibers or identical singlemode optical fibers, located in proximity to the focal plane of their associated collimating lenses,

3. A multi-channel fiber optic rotary joint according to claim 2, wherein said fiber optic collimators include identical gradient-index rod lenses,

4. A multi-channel fiber optic rotary joint according to claim 3, wherein the collimators of said data transmission channels have varying working distances.

5. A multi-channel fiber optic rotary joint according to claim 4, a first number of said data transmission channels include fiber optic collimators having working distances that may be achieved with ideally zero insertion losses by means of quarter-pitch gradient-index rod lenses affixed to said fibers by means of optically-transparent epoxy, defining a desired axial form factor,

6. A multi-channel fiber optic rotary joint according to claim 5, wherein a second number of said data transmission channels include fiber optic collimators having working distances that may not be achieved with ideally zero insertion losses by means of quarter-pitch gradient-index lenses, but that may be achieved by means of shorter-than-quarter-pitch gradient-index rod lenses,

7. A multi-channel fiber optic rotary joint according to claim 6, wherein a third number of said data transmission channels include fiber optic collimators having working distances that may not be achieved with ideally zero insertion loss by means of quarter-pitch gradient-index rod lenses, but that may be achieved by means of shorter-than-quarter-pitch gradient-index rod lenses.

8. A multi-channel fiber optic rotary joint according to claim 7, wherein said shorter-than-quarter-pitch gradient-index rod lenses are affixed to cylindrical glass spacers by means of optically-transparent epoxy, and wherein the axial lengths of said cylindrical glass spacers are selected to locate the focal planes of said shorter-than-gradient-index rod lenses proximal to said cylindrical glass spacers physically outside of said cylindrical glass spacers.

9. A multi-channel fiber optic rotary joint according to claim 8, wherein said cylindrical glass spacers have diameters equal to, or less than, the diameters of said shorter-than-quarter-pitch gradient-index rod lenses.

10. A multi-channel fiber optic rotary joint according to claim 9, wherein said shorter-than-quarter-pitch gradient-index rod lenses and said cylindrical glass spacers have end faces which are polished to orientations which are not perpendicular to the optical axes of said shorter-than-quarter-pitch gradient-index rod lenses, for the purpose of minimizing back reflections.

11. A multi-channel fiber optic rotary joint according to claim 10, wherein said optical fibers are affixed to said cylindrical glass spacers by means of optically-transparent epoxy,

12. A multi-channel fiber optic rotary joint according to claim 11, wherein said fiber optic collimators include said shorter-than-quarter-pitch gradient-index rod lenses, said cylindrical glass spacers, and optical fibers that conform to the desired axial form factor.

13. A multi-channel fiber optic rotary joint according to claim 7, wherein said shorter-than-quarter-pitch gradient-index rod lenses are affixed to cube reflector prisms by means of optically-transparent epoxy, with the width of said cube reflector prisms selected to locate the focal planes of said shorter-than-quarter-pitch gradient-index rod lenses physically outside of said cube reflector prisms, with the optical axis of said shorter-than-quarter-pitch gradient-index rod lenses thereby bent by 90 degrees,

14. A multi-channel fiber optic rotary joint according to claim 13, wherein said cube reflector prisms include a highly-reflective metallic coating applied to a prepared glass substrate and a second glass substrate affixed to said highly-reflective metallic coating by means of an optically-transparent epoxy.

15. A multi-channel fiber optic rotary joint according to claim 14, wherein said optical fibers are affixed to said cube reflector prisms by means of an optically-transparent epoxy, wherein said optical fiber axes are oriented at 90 degrees to the optical axes of said shorter-than-quarter-pitch gradient-index rod lenses,

16. A multi-channel fiber optic rotary joint according to claim 15, wherein one of said cube reflector prisms is replaced by a cylindrical glass spacer of equal optical path length, wherein said optical fiber is oriented parallel to the optical axis of said shorter-than-quarter-pitch gradient-index rod lens.

17. A multi-channel fiber optic rotary joint according to claim 7, wherein said shorter-than-quarter-pitch gradient-index rod lenses are affixed to right-angle prisms by means of optically-transparent epoxy, with the width of said right-angle prisms selected to locate the focal planes of said shorter-than-quarter-pitch gradient-index rod lenses physically outside of said right-angle prisms, with the optical axes of said shorter-than-quarter-pitch gradient-index rod lenses thereby bent by 90 degrees.

18. A multi-channel fiber optic rotary joint according to claim 17, wherein said right-angle prisms are comprised of a highly-reflective multi-layer dielectric coating applied to the hypotenuse of a standard right-angle prism,

19. A multi-channel fiber optic rotary joint according to claim 18, wherein said optical fibers are affixed to said right angle prisms by means of optically-transparent epoxy, wherein said optical fiber axes are oriented at 90 degrees to the optical axes of said shorter-than-quarter-pitch gradient-index rod lenses,

20. A multi-channel fiber optic rotary joint according to claim 19, wherein one of said right-angle prisms is replaced by a cylindrical glass spacer of equal optical path length, wherein said optical fiber is oriented parallel to the optical axis of said shorter-than-quarter-pitch gradient-index rod lens.
